(19) United States
(12) Patent Application Publication
(10) Pub. No.: US 2012/0277366 A1
(43) Pub. Date: Nov. 1, 2012

(54) INKJET PRINTING FLUID

(76) Inventors: Mark R. Mis, Hornell, NY (US); Grace Ann Bennett, Scottsville, NY (US); Catherine A. Falkner, Rochester, NY (US)

(21) Appl. No.: 13/097,137

(22) Filed: Apr. 29, 2011

(51) Int. Cl. C09D 175/04

(52) U.S. Cl. 524/507

(57) ABSTRACT

An inkjet printing fluid composition comprising water, colorant, acrylic latex polymer, and a water dispersible polyurethane additive having an acid number greater than 50, preferably between 50 and 150, more preferably from 60 to 100, and most preferably from 60 to 90. The invention provides inkjet printing fluid compositions, such as pigment-based inkjet printing inks, which contain an acrylic latex polymer which provides increased optical density for printed images, and a water dispersible polyurethane additive that enables the latex-containing printing fluid to be recirculated for extended periods in a recirculating printing fluid printing system without significant fluid destabilization or pressure build up or filter clogging. The invention further provides a method for printing an inkjet image comprising: I) providing an inkjet printing fluid according to the invention; and II) jetting the inkjet printing fluid in the form of ink drops onto a recording element to form a printed image.

### CROSS-REFERENCE TO RELATED APPLICATIONS

Reference is made to commonly assigned U.S. Ser. No. ______ (Kodak Docket K000022) filed concurrently herewith, directed towards “Recirculating Fluid Printing System and Method,” the disclosure of which is incorporated by reference herein in its entirety.

### FIELD OF THE INVENTION

The invention relates generally to the field of inkjetprinting fluids, and in particular to inks which are useful for printing systems employing recirculating printing fluids such as continuous inkjet printing systems. More specifically, the invention relates to specially formulated inks for continuous inkjet printing systems which result in high density printed images without printer fluid destabilization and filter plugging during recirculation.

### BACKGROUND OF THE INVENTION

Inkjet printing is a non-impact method for producing printed images by the deposition of ink droplets in a pixel-by-pixel manner to an image-recording element in response to digital signals. There are various methods that can be used to control the deposition of ink droplets on the image-recording element to yield the desired printed image. In one process, known as drop-on-demand inkjet, individual droplets are projected as needed onto the image-recording element to form the desired printed image. Common methods of controlling the ejection of ink droplets in drop-on-demand printing include thermal bubble formation (thermal inkjet (TIJ)) and piezoelectric transducers. In another process known as continuous inkjet (CIJ), a continuous stream of droplets is generated and expelled in an image-wise manner onto the surface of the image-recording element, while non-imaged droplets are deflected, caught, and recycled to an ink sump. Inkjet printers have found broad applications across markets ranging from desktop document and photographic-quality imaging, to commercial printing and industrial labeling.

Continuous inkjet (CIJ) printers typically consist of two main components, a fluid system and one or more printheads. Ink is delivered through a supply line from a supply reservoir to a manifold that distributes the ink to a plurality of orifices, typically arranged in linear array(s), under sufficient pressure to cause ink streams to issue from the orifices of the printhead. Stimulations are applied to the printhead to cause those ink streams to form streams of spaced droplets, which are deflected into printing or non-printing paths. The non-printing droplets are recirculated by being returned to the supply reservoir via a droplet catcher and a return line. U.S. Pat. Nos. 4,734,711 and 5,394,177 and EP 1,013,450 describe in detail the design of a fluid system for CIJ apparatus. The more recent development of CIJ printing apparatus and printhead fabrication can be found in U.S. Pat. Nos. 6,588,888 and 6,943,037. Ink drop uniformity in CIJ printers requires maintaining a uniform pressure in the printhead cavity. U.S. Pat. No. 4,614,948 describes that a positive displacement pump, such as gear pump, is preferred for use as the ink supply pump. The need to limit pulsation produced by the pump is recognized in U.S. Pat. No. 4,971,527. In addition, filters are employed at appropriate locations in fluid system to remove oversized particles prior to ink entering into printhead orifices and avoid printhead clogging.

Ink compositions containing colorants used in inkjet printers can be classified as either pigment-based, in which the colorant exists as pigment particles suspended in the ink composition, or as dye-based, in which the colorant exists as a fully solvated dye species that includes one or more dye molecules. In such traditional dye-based inks, no colorant particles are observable under the microscope. CIJ inks traditionally have been mostly aqueous dye-based inks, where issues regarding robust system runnability, such as easy start up/shut down, extended printing time without crooked jet, and reduced frequency for filter changing have been minimized. Although there have been many recent advances in the art of dye-based inkjet inks, such inks still suffer from deficiencies such as low optical densities on coated glossy paper and poor light-fastness. When water is used as the carrier, such inks also generally suffer from poor water fastness and poor smear resistance.

Pigments are highly desirable for use in inkjet inks since they are far more resistant to fading than dyes. However, pigment-based inks have a number of potential drawbacks. Great lengths are undertaken to reduce a pigment particle to a sufficiently small particle size and to provide sufficient colloidal stability to the particles. Pigment-based inks often require a lengthy milling operation to produce particles in the sub-micron range needed for most modern ink applications. If the pigment particles are too large, light scattering can have a detrimental effect on optical density and gloss in the printed image, and filter plugging issues may also be encountered when running pigment inks in a CIJ or other recirculating fluid printing system, requiring frequent change of filters, e.g., over the time period of a few hours vs. a few months for dye-based inks. The consequence of filter plugging is the loss of fluid pressure and fluid jets, leading to system shutdown. Further investigation has discovered that the gear pump commonly used in the CIJ fluid system to maintain fluid pressure with minimal pulsation can cause destabilization and agglomeration of pigment or other particle dispersions in an ink, leading to filter clogging and system shutdown. Such destabilization and filter plugging can also be a problem with other printing systems employing recirculating printing fluids, such as where a recirculation system is used to recirculate printing fluid continuously through a drop on demand printhead, or to an ink tank associated with such a printhead.

A further potential drawback of pigmented inks is their durability after printing, especially under conditions where abrasive forces have been applied to the printed image. Pigment-based inks typically reside at the surface of the imaging receiver to which they are printed and this makes the printed images particularly susceptible to abrasive forces. To this extent, pigmented inks have been formulated with various polymers, dispersants, and other addenda to provide durable images that can withstand post printing physical abuse and environmental conditions. Pigmented inks for inkjet printing have been formulated with acrylic polymers, e.g., typically in the form of water soluble polymers. Alternatively, acrylic latex polymers may be employed, such as described in, e.g., U.S. Pat. Pub. Nos. 2005/0176847 and 2008/0186373, and U.S. Pat. No. 7,696,262. Water-soluble acrylic polymers, however, alone are typically insufficient in providing durable high density images, and may increase an ink's viscosity to higher levels than desired, especially for recirculating ink printing systems. Latex particulate polymers, on the other hand, may contribute to undesired filter plugging in recirculating fluid printing systems.

A second class of polymers that have been used as abrasion resistance additives in pigment-based inks are the polyurethanes, or urethane resins as they are sometimes called. U.S. Pat. No. 6,136,890 discloses a pigment-based inkjet ink wherein the pigment particles are stabilized by a polyurethane dispersant. US Publication No. 2004/0242726 discloses a pigment dispersed by a cross-linking step between a resin having a urethane bond and a second water-soluble polymer. Although polyurethanes are known for their excellent abrasion resistance, they also have a number of drawbacks. For example, not all polyurethane polymers are conducive to jetting from a thermal inkjet head. In particular, water-dispersible polyurethane particles, such as those disclosed in U.S. Pat. Nos. 6,533,408 and 6,268,101, Statutory Invention Registration No. US H2113H, and US Publication Numbers 2004/0130608 and 2004/0229976 are particularly difficult to jet from a thermal inkjet printhead at high firing frequencies. Further, addition of polyurethanes at high levels for abrasion resistance can also substantially increase the viscosity of a printing fluid.

### SUMMARY OF THE INVENTION

It is an object of this invention to provide inkjet printing fluid compositions, including pigment-based inks, containing an acrylic latex that provides improved optical density in a printed image. It is a further object of this invention to provide such printing fluids for CIJ printing systems which enable the ink to be recirculated in a CIJ fluid system for extended periods without significant pressure build up or filter clogging.

In accordance with one embodiment, the invention provides an inkjet printing fluid composition comprising water, colorant, acrylic latex polymer, and a water dispersible polyurethane additive having an acid number greater than 50, preferably between 50 and 150, more preferably from 60 to 100, and most preferably from 60 to 90.

The invention provides inkjet printing fluid compositions, such as pigment-based inkjet printing inks, which contain an acrylic latex polymer which provides increased optical density for printed images, and a water dispersible polyurethane additive that enables the latex-containing printing fluid to be recirculated for extended periods in a recirculating printing fluid printing system without significant fluid destabilization or pressure build up or filter clogging.

The invention further provides a method for printing an inkjet image comprising: I) providing an inkjet printing fluid according to the invention; and II) jetting the inkjet printing fluid in the form of ink drops onto a recording element to form a printed image.

### BRIEF DESCRIPTION OF THE DRAWINGS

In the detailed description of the example embodiments of the invention presented below, reference is made to the accompanying drawing, in which:

FIG. 1 shows a schematic diagram of a continuous inkjet printing system employed in accordance with an embodiment of the present invention.

FIG. 2 is a graph illustrating the change in pressure of inks containing polyurethanes of varying acid number upon recirculation in a test system described in the Examples.

### DETAILED DESCRIPTION OF THE INVENTION

Recirculating printing fluid printing systems useful for applying a printing fluid in accordance with the present invention to a substrate comprise a printing fluid applicator and a recirculating printing fluid supply supplying the printing fluid to the applicator. Printing fluid applicators include, e.g., conventional inkjet printheads and fluid spray devices. In a particular embodiment, printing fluids of the invention are designed for printing with a continuous inkjet printer. In such CIJ printers, a continuous stream of droplets is generated, a portion of which are deflected in an image-wise manner onto the surface of the image-recording element, while un-imaged droplets are caught and returned to an ink sump. In the system of continuous inkjet printing a main fluid supply is provided with the printing fluid composition, which is then delivered from the main fluid supply to a printhead, where a continuous stream of the ink composition is ejected from the printhead, which continuous stream then is broken into spaced droplets. In response to electrical signals received from a control mechanism, the droplets are then selected between printing droplets for marking a substrate and nonprinting droplets that are collected and returned to the main fluid supply. Continuous inkjet systems which may be used in accordance with specific embodiments of the present invention include those disclosed, e.g., in U.S. Pat. Nos. 6,588,888, 6,554,410, 6,682,182, and 6,575,566 to Jeanmaire et al.; US Publication No. 2003/0202054 to Jeanmaire et al.; U.S. Pat. Nos. 6,793,328 and 6,866,370 to D. Jeanmaire; and U.S. Pat. No. 6,517,197 to Hawkins et al.; the disclosures of which are herein incorporated in their entirety by reference. In another embodiment, an apparatus capable of controlling the direction of the formed printing and non-printing drops by asymmetric application of heat to the fluid stream that initializes drop break-up and serves to steer the resultant drop may be employed, as disclosed in U.S. Pat. Nos. 6,079,821 and 6,505,921 to Chwalek et al., the disclosures of which are herein incorporated in their entirety by reference. Useful ink agitation, heated ink supply and printhead and fluid filtration means for CIJ pigmented inkjet ink compositions are described in U.S. Pat. No. 6,817,705 to Crockett et al., the disclosure of which is herein incorporated in its entirety by reference. Printer replenishing systems for maintaining ink quality and countering the effects of ink volatile component evaporation are described in U.S. Pat. No. 5,526,026 to M. Bowers and U.S. Pat. No. 5,473,350 to Mader et al., and EP 0 597 628 A1 to Loyd et al., the disclosures of which are herein incorporated in their entirety by reference.

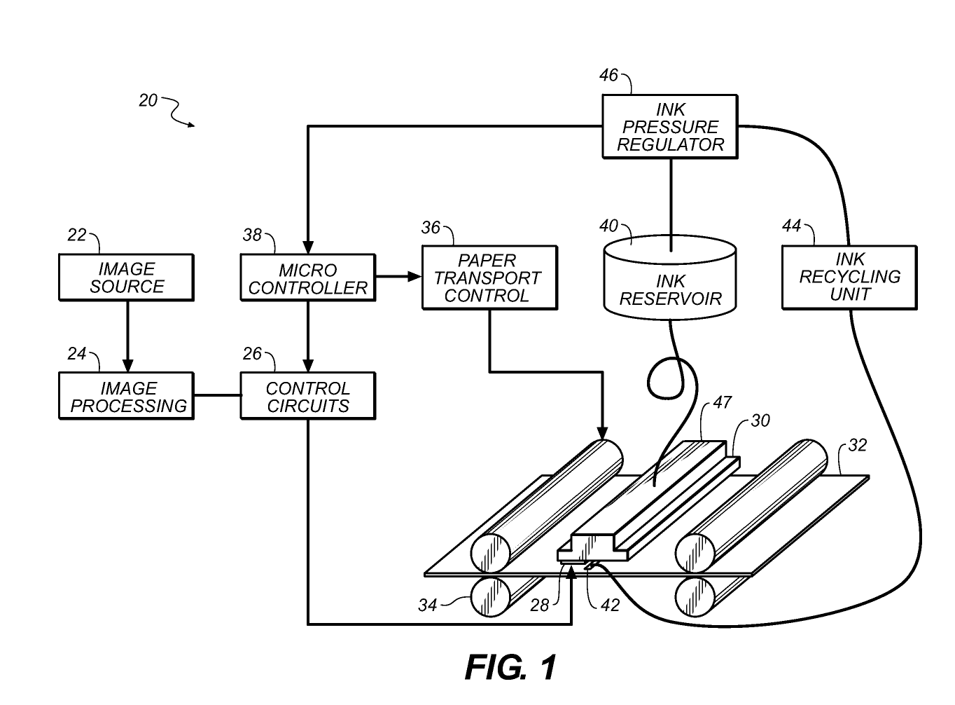

Referring to FIG. 1, a continuous printing system 20 includes an image source 22 such as a scanner or computer which provides raster image data, outline image data in the form of a page description language, or other forms of digital image data. This image data is converted to half-toned bitmap image data by an image processing unit 24 which also stores the image data in memory. A plurality of drop forming mechanism control circuits 26 read data from the image memory and apply time-varying electrical pulses to a drop forming mechanism(s) 28 that are associated with one or more nozzles of a printhead 30. These pulses are applied at an appropriate time, and to the appropriate nozzle, so that drops formed from a continuous inkjet stream will form spots on a recording medium 32 in the appropriate position designated by the data in the image memory. Recording medium 32 is moved relative to printhead 30 by a recording medium transport system 34, which is electronically controlled by a recording medium transport control system 36, and which in turn is controlled by a micro-controller 38. The recording medium transport system shown in FIG. 1 is a schematic only, and many different mechanical configurations are possible. For example, a transfer roller could be used as recording medium transport system 34 to facilitate transfer of the ink drops to recording medium 32. Such transfer roller technology is well known in the art. In the case of page width printheads, it is most convenient to move recording medium 32 past a stationary printhead. However, in the case of scanning print systems, it is usually most convenient to move the printhead along one axis (the sub-scanning direction) and the recording medium along an orthogonal axis (the main scanning direction) in a relative raster motion.

Ink is contained in an ink reservoir 40 under pressure. In the non-printing state, continuous inkjet drop streams are unable to reach recording medium 32 due to an ink catcher 42 that blocks the stream and which may allow a portion of the ink to be recycled by an ink recycling unit 44. The ink recycling unit reconditions the ink and delivers it back to reservoir 40. Such ink recycling units are well known in the art. The ink pressure suitable for optimal operation will depend on a number of factors, including geometry and thermal properties of the nozzles and thermal properties of the ink. A constant ink pressure can be achieved by applying pressure to ink reservoir 40 under the control of ink pressure regulator 46. Alternatively, the ink reservoir can be left unpressurized, or even under a reduced pressure (vacuum), and a pump is employed to deliver ink from the ink reservoir under pressure to the printhead 30. In such an embodiment, the ink pressure regulator 46 can comprise an ink pump control system. As shown in FIG. 1, catcher 42 is a type of catcher commonly referred to as a “knife edge” catcher. The ink is distributed to printhead 30 through an ink channel 47. The ink preferably flows through slots or holes etched through a silicon substrate of printhead 30 to its front surface, where a plurality of nozzles and drop forming mechanisms, for example, heaters, are situated. When printhead 30 is fabricated from silicon, drop forming mechanism control circuits 26 can be integrated with the printhead. Printhead 30 also includes an ink drop deflection mechanism (not shown), such as described in the above referenced patents.

In an alternative embodiment, inkjet printing fluids of the invention may be designed for use in an independently operated printing fluid applicator (such as a drop-on-demand printhead), which may be employed with a separate recirculating printing fluid supply which delivers the printing fluid from a main fluid supply to the printhead, or an ink tank associated with the printhead, and recirculates non-printed printing fluid (i.e., printing fluid which has not been ejected through printing jets of the printhead) back to the main fluid supply. Such alternative system may be applicable, e.g., when it is desired to maintain a relatively large ink supply for a drop-on-demand system, or where it is otherwise desired to maintain the printing fluid supply in a state of agitation by recirculation. In drop-on-demand inkjet, individual ink droplets are projected as needed onto the image-recording element to form the desired printed image. Common methods of controlling the projection of ink droplets in drop-on-demand printing include piezoelectric transducers, thermal bubble formation (thermal inkjet), or an actuator that is made to move. Exemplary thermal drop-on-demand printheads, e.g., are described in U.S. Pat. No. 7,350,902. Drop on demand printers typically include one or more ink tanks that supply ink to the printhead, and a source of image data that provides signals that are interpreted by a controller as being commands to eject drops of a selected ink from the printhead. Printheads may be integral with the ink tanks, or separate. A separate recirculating printing fluid supply may be employed to deliver printing fluid from a main fluid supply to the printhead, or to an ink tank associated with the printhead, and continuously recirculate non-printed printing fluid (i.e., printing fluid which has not been ejected through printing jets of the printhead) back to the main fluid supply.

The inkjet printing fluids of the present invention are aqueous-based printing fluids. “Aqueous-based” is defined herein to mean the printing fluid comprises mainly water as the carrier medium for the remaining printing fluid components. In a preferred embodiment, the printing fluids of the present invention comprise at least about 50 weight percent water. In a specific embodiment, the printing fluid is a pigment-based ink. Pigment-based inks are defined as inks containing at least a dispersion of water-insoluble pigment particles.

An ink set is defined as a set of two or more inks. An ink set may contain pigment-based inks of different colors, for example, cyan, magenta, yellow, red, green, blue, orange, violet, or black. In one embodiment, a carbon black pigmented ink is used in an ink set comprising at least three inks having separately, a cyan, a magenta, and a yellow colorant. Useful ink sets also include, in addition to the cyan, magenta, and yellow inks, complimentary colorants such as red, blue, violet, orange, or green inks. In addition, the ink set may comprise light and dark colored inks, for example, light cyan and light magenta inks commonly used in the ink sets of wide format printers. It is possible to include one or more inks that comprise a mixture of different colored pigments in the ink set. An example of this is a carbon black pigment mixed with one or more colored pigments or a combination of different colored pigments. An ink set may also include one or more pigment-based inks in combination with one or more clear inks. An ink set may also include at least one or more pigment-based inks in combination with additional inks that are dye-based ink. An ink set may further comprise one or more inks containing a self-dispersing carbon black pigment ink which is used primarily for printing of text and a plurality of cyan, magenta, yellow, and black inks which are used primarily for photographic quality printing.

Printing fluid compositions of the present invention comprise an acrylic latex polymer, preferably at levels from 1 to 20% by weight based on the total printing fluid components, more preferably from 2 to 20% by weight and most preferably from 6 to 15% by weight. These ranges provide improved optical density and durability of printed images. The acrylic latex polymer is present in the printing fluid in the form of a latex, i.e., primarily in the form of dispersed polymer particles. The term “latex” or “latex dispersion” refers to both the latex polymer particles themselves as well as the aqueous medium in which the polymer particles are dispersed. More specifically, a latex is a liquid suspension comprising a liquid (such as water and/or other liquids) and polymeric particulates, typically ranging from about 20 nm to 500 nm in size, and having a weight average molecular weight from about 10,000 Mw to 2,000,000 Mw (preferably from about 40,000 Mw to 100,000 Mw). Such polymeric particulates can comprise a plurality of monomers that are typically randomly polymerized, and can also be crosslinked. When crosslinked, the molecular weight can be even higher than that cited above.

The terms “latex polymer” or “latex polymer particles” refer to the polymeric masses that are dispersed in a latex dispersion. The term “acidified latex particulates” refers to neutralized acid groups of latex particulates that can be present at the surface of latex particulates. The acid groups provide the colloidal latex particles with electrostatic stabilization to avoid particle to particle aggregation. Specifically, latex particulates having surface acid groups tend to be more stable over longer periods of time, and tend to resist aggregation. These acid groups can be present throughout the latex particulates, including on the surfaces, or can be more concentrated at the surfaces. In a more detailed aspect, the latex particulates can be prepared using acid monomers copolymerized with other monomers to form a monomer emulsion, which in turn, is initiated to form the latex particulates. The acid functionalities are neutralized to provide a surface charge on the latex particles. In this exemplary embodiment, the acid monomers can be present at from approximately 0.1 wt % to 15 wt % of total monomers used to form the latex particulates. Typical acids that have been used to acidify the surface of latex particulates included carboxylic acids, though stronger acids can also be used, such as sulfonic acids. Carboxylic acids are weak acids that have been fairly effective for use in latex/ink-jet ink systems. For example, methacrylic acid functionalized latex particulates can be formed using 5-10 wt % methacrylic acid. During preparation, a fraction of the methacrylic acid monomers may stay in the particle phase and the balance may migrate to the aqueous phase of the emulsion.

In another exemplary embodiment, the latex particulates employed in the present invention can be provided by multiple monomers copolymerized to form the latex particulates, wherein the multiple monomers include at least one crosslinking monomer present at from approximately 0.1 wt % to 10 wt % of total monomers used to form the latex particulates. Such a crosslinking monomer does not provide the acid groups but can provide other properties to the latex that can be desirable for ink-jet applications.

Exemplary monomers that can be used to form latex particulates useful in the present invention include, but are in no way limited to, styrenes, C1 to C8 alkyl methacrylates, C1 to C8 alkyl acrylates, ethylene glycol methacrylates and dimethacrylates, methacrylic acids, acrylic acids, sulfonates, and the like. Non-limiting specific examples of the acrylic latex polymer further include polymer colloid particulates having surface acid groups further described in U.S. Patent Publication No. 2005/0176847, which is incorporated herein by reference in its entirety.

In a preferred embodiment of the invention, the acrylic latex preferably comprises less than 20 wt % of the acrylic latex polymer as free solution polymer, where “free solution polymer” is defined as that portion of the polymer in an aqueous dispersion which is visible in an ¹H NMR spectrum of the aqueous dispersion, where the measured ¹H integral is compared to the integral of the completely dissolved polymer. More preferably, the acrylic latex comprises less than 10 wt % of the acrylic latex polymer as free solution polymer, and most preferably comprises less than 4 wt % of the acrylic latex polymer as free solution polymer.

Printing fluid compositions of the present invention further comprise at least one water-dispersible polyurethane additive. “Water-dispersible” is defined herein to mean individual polymer molecules or colloidal assemblies of polymer molecules which are stably dispersed in the printing fluid without the need for a dispersing agent. Water dispersible polyurethanes employed in the present invention may have, e.g., the general formula of (IA), (IB), or (IC):

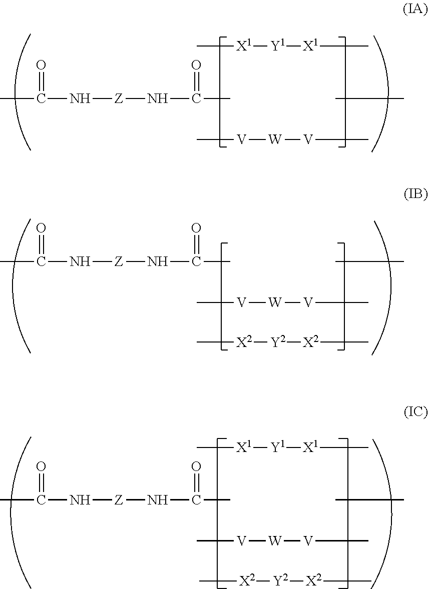

wherein Z is the central portion of a monomer unit that is the polymerization product of a diisocyanate; X¹—Y¹—X¹ represents one or more soft segments wherein Y¹ represents the central portion of a unit that is the polymerization product of a diamine or diol prepolymer having a molecular weight of greater than 300 Daltons; W is the central portion of one or more units containing an acid group; X²—Y²—X² represents one or more hard segments wherein Y² represents the central portion of a unit that is the polymerization product of a C₂-C₈ diol or diamine having a molecular weight of less than or equal to 300 Daltons; and X¹, V and X² can be the same or different and are an —O— or —N— atom. The polyurethane additive preferably has a weight average molecular weight of at least 6,000 Daltons, and a sufficient number of acid groups to provide an acid number between 50 and 150, more preferably from 60 to 100, and most preferably from 60 to 90. Polyurethanes of formulae (IA) and (IC) containing X¹—Y¹—X¹ soft segments are preferred, and when present, the one or more X²—Y²—X² hard segments are preferably present at from 1 wt % to less than 13 wt % of the polyurethane additive.

Z in the above formulae is typically a hydrocarbon group having a valence of two, more desirably containing a substituted or unsubstituted alicyclic, aliphatic, or aromatic group, preferably represented by one or more of the following structures:

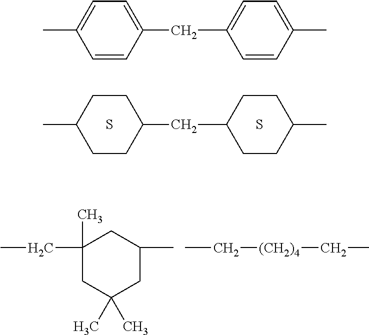

X¹—Y¹—X¹ in the above formulae represents one or more soft segments wherein Y¹ represents the central portion of a unit that is the polymerization product of a diamine or diol prepolymer having a molecular weight of greater than 300 Daltons, preferably from about 400 to 20,000 Daltons. Such soft segments may be derived from, e.g., a polyether polyol, polyester polyol, polycarbonate polyol, polydimethyl siloxane diol, polyether diamine, polyester diamine, polycarbonate diamine, or aminoalkyl terminated polydimethyl siloxane. Useful polyether diols and diamines are those sold under the trade name TERATHANE from Dupont and trade name JEFFAMINE D, ED, and M series from Huntsman. A particularly useful polyether polyol useful for forming the soft segment is tetramethylene glycol and can desirably have a molecular weight between 300 and 2500. A particularly useful polyether diamine is a bis(3-aminopropyl) terminated polytetrahydrofuran having a molecular weight between 600 and 2000. Additional useful soft segments for the polyurethane include a polydimethylsiloxane diol or aminoalkyl terminated polydimethyl siloxane, and fluorinated prepolymers comprising fluorinated side chains. Useful fluorinated side chains include fluoroalkyls and fluorinated polyethers. Fluorinated soft segments may be similarly introduced into the polyurethane backbone by using a prepolymer with both ends terminated with a hydroxyl (diol) or an amino (diamine) group. Polyurethane additives employed in the present invention may comprise a single type of soft segment, or a mixture of two or more distinct soft segments. The X¹—Y¹—X¹ soft segments are preferably present in the polyurethane at from about 1% to 75% by weight, more preferably from 2% to 70%, and desirably from 5% to 60% based on the total weight of the polymer.

W is preferably the central portion of a monomeric unit containing a phosphoric acid, carboxylic acid, or sulfonic acid group, most preferably being carboxylic acids, such as 2,2′-bis(hydroxymethyl)propionic acid, 2,2′-bis(hydroxymethyl)butyric acid, and hydroxyethylether of 4,4′-bis(4-hydroxyphenyl)valeric acid.

X²—Y²—X² represents one or more hard segments, wherein Y² represents the central portion of a unit that is the polymerization product of a C₂-C₈ diol or diamine having a molecular weight of less than 300 Daltons. Such hard segments preferably comprise the polymerization product of a C₂-C₈ diol, e.g., ethylene glycol, 1,3-propane diol, 1,4-butane diol, 1,5-pentanediol, 1,6-hexane diol, 2-methyl 1,3-propane diol, 3-methyl 1,5-pentane diol, or cyclohexane dimethanol, most preferably 1,4-butanediol.

Conventional processes of making polyurethane dispersions involve the steps of preparing a prepolymer having a relatively low molecular weight and a small excess of isocyanate groups and chain-extending with a chain extender the prepolymers into a high molecular weight polyurethane during the dispersion process. Besides the raw materials the polyurethane dispersions sold by various manufacturers differs in the process used to prepare the prepolymers (e.g Solvent free prepolymer process, Ketimine and Ketazine process, Hybrid system, and Ethyl acetate process), and the type of chain extender used in the dispersion step. Such materials and processes have been disclosed in, for example, U.S. Pat. No. 4,335,029; in “Aqueous Polyurethane Dispersions,” by B. K. Kim, Colloid & Polymer Science, Vol. 274, No. 7 (1996) 599-611, Steinopff Verlag 1996; and in “Polyurethane Dispersion Process,” by Manea et al., Paint and Coating Industry, January 2007, Page 30.

The polyurethane dispersions useful for the practice of this invention are desirably to be prepared without involving the chain-extension step during the dispersion step. Instead it is preferable to have the chemical reaction for forming urethane or urea linkages completed prior to the dispersion step. This will insure that the polyurethane dispersions used in the printing fluid compositions employed in the invention have well-controlled molecular weight and molecular weight distribution and be free of gel particles.

In one particularly useful process the polyurethane used in the present invention may be prepared in a water miscible organic solvent such as tetrahydrofuran, followed by neutralizing the hydrophilic groups, e.g. carboxylic acid groups, with an organic amine, e.g., dimethylethanol amine or triethanol amine, or aqueous inorganic base, e.g. potassium hydroxide solution. The polyurethane solution is then diluted with doubly distilled de-ionized water. Finally the water miscible organic solvent is removed by distillation to form stable polyurethane dispersions. In this process the polyurethane particles are formed by precipitation during solvent evaporation.

In a second useful process the polyurethane used in the invention may be prepared in a water immiscible organic solvent, e.g. ethyl acetate. The polyurethane is neutralized with an organic amine, e.g., dimethylethanol amine or triethanol amine, or aqueous inorganic base and water is added to form an aqueous dispersion comprising primarily minute drops of polyurethane-water immiscible organic solvent solution suspended in water. The water immiscible organic solvent is then removed to form the desired polyurethane dispersion.

In another useful process the polyurethane may be formed by a sequential polymerization process where a soft polyurethane segment is formed first by reacting a diisocyanate compound with a polyether diol or diamine. The soft polyurethane segment then reacts further with a mixture of diisocyanate compound, a hard segment polyol, and a low molecular weight diol having a hydrophilic group, e.g. a carboxylic acid group.

The polyurethane employed in this invention has a sufficient amount of acid groups in the molecule to have an acid number of greater than 50. The acid number is defined as the milligrams of potassium hydroxide required to neutralize one gram of dry polymer. The acid number of the polymer may be calculated by the formula given in the following equation: Acid number=(moles of acid monomer)*(56 grams/mole)*(1000)/(total grams of monomers) where, moles of acid monomer is the total moles of all acid group containing monomers that comprise the polymer, 56 is the formula weight for potassium hydroxide, and total grams of monomers is the summation of the weight of all the monomers, in grams, comprising the target polymer. In order to achieve optimal jetting from a drop-on-demand thermal inkjet printhead, the acid number is preferably at least 65, more preferably at least 75, and most preferably at least 80. In order to provide improved durability, the acid number is preferably less than 150 and more preferably at most 120.

In contrast to drop-on-demand printing, CIJ is a very high speed printing process, and it is desired to operate at substrate transport speeds in excess of 100 m/min. Printing speed alone imposes some limitations on ink formulation relative to slower drop-on-demand printing techniques, simply on the basis of the short time requirements for adequately drying the printed substrate moving at full speed in the press before roll wind-up. Surprisingly, features of CIJ printhead operation can allow wider ink formulation latitude than is possible in DOD printing in other respects, however. Ink formulation considerations specific to traditional CIJ printing are described in W. Wnek, IEEE Trans. 1986, 1475-81, which elucidates the ink performance requirements for drop formation, deflection and catching of non-printing drops, recirculation of the ink to the printhead from the storage reservoir for future printing, and also for commercial ink-media image quality and durability. In order to achieve improved dispersion stability in inkjet printing systems employing an acrylic latex-containing printing fluid and a recirculating fluid supply, such as in continuous inkjet systems, use of polyurethanes with an acid number of greater than 50, and preferably between 50 and 150 (more preferably from 60 to 90, and most preferably 60 to 90) are employed.

The acid groups on the polyurethane compounds employed in the present invention may be at least partially neutralized (converted into salts) using organic amine, e.g., dimethylethanol amine or triethanol amine, or monovalent inorganic base, preferably an alkaline metal hydroxide selected from the group of potassium hydroxide, sodium hydroxide, rubidium hydroxide, or lithium hydroxide. In a preferred embodiment, at least 70 percent of the available acid groups on the polymer are converted into salts using inorganic base, more preferably, at least 90% of the available acid groups are converted. From a manufacturing perspective, preferably less than 100% of the acid groups are neutralized as this can lead to lack of control of the pH of the printing fluids.

The polyurethanes employed in the invention preferably have a minimum weight average molecular weight of at least 6,000 Daltons, more preferably at least 8,000 Daltons. Desirably, the polyurethane has a maximum weight average molecular weight of 150,000. Polyurethanes having too low molecular weight may provide insufficient durability and often exhibit poor jetting performance. Molecular weights above 150,000, on the other hand, may have negative impacts on the relatively low viscosity requirements of an inkjet printing fluid which are desirably jetted at high frequencies and with low variability. More typically the molecular weight of polyurethanes employed in the invention is from 10,000 to 100,000, more desirably from 15,000 to 70,000. The polyurethane dispersions useful for the practice of this invention preferably have a mean particle size of less than 100 nm.

Printing fluid compositions employed in the present invention preferably comprise polyurethanes at levels from 0.1 to 10% by weight based on the total printing fluid components. For drop-on-demand thermal printhead systems, polyurethane concentrations of from 0.1% to 5%, more preferably 0.5 to 3%, based on the total printing fluid composition may be employed. These ranges of polyurethane provide excellent jetting of the printing fluid composition from the printhead while minimizing viscosity effects that could affect jetting performance. For continuous inkjet printing systems, polyurethane concentrations of from 0.5 to 5% by weight, more preferably from 0.5 to 3.0% by weight and most preferably 0.5 to 2% by weight may be employed to provide improved recirculation stability. To provide improved optical density while maintaining desired viscosity and recirculation stability, the weight concentration of the acrylic latex polymer preferably is greater than the weight concentration of the pigment, and the weight concentration of the pigment preferably is greater than the weight concentration of the polyurethane additive.

Unless otherwise specifically stated, use of the term “substituted” or “substituent” means any group or atom other than hydrogen. Additionally, when the term “group” is used, it means that when a substituent group contains a substitutable hydrogen, it is also intended to encompass not only the substituent's unsubstituted form, but also its form further substituted with any substituent group or groups as herein mentioned, so long as the substituent does not destroy properties necessary for device utility. Suitably, a substituent group may be halogen or may be bonded to the remainder of the molecule by an atom of carbon, silicon, oxygen, nitrogen, phosphorous, sulfur, selenium, or boron. The substituent may be, for example, halogen, such as chloro, bromo or fluoro; nitro; hydroxyl; cyano; carboxyl; or groups which may be further substituted, such as alkyl, including straight or branched chain or cyclic alkyl, such as methyl, trifluoromethyl, ethyl, t-butyl, 3-(2,4-di-t-pentylphenoxy) propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-tolylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N N-diphenylureido, N-phenyl-N-p-tolylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-tolylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-tolylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-tolylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1 (N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3 to 7 membered heterocyclic ring composed of carbon atoms and at least one hetero atom selected from the group consisting of oxygen, nitrogen, sulfur, phosphorous, and boron, such as 2-furyl, 2-thienyl, 2-benzimidazolyloxy or 2-benzothiazolyl; quaternary ammonium, such as triethylammonium; quaternary phosphonium, such as triphenylphosphonium; and silyloxy, such as trimethylsilyloxy.

If desired, the substituents may themselves be further substituted one or more times with the described substituent groups. The particular substituents used may be selected by those skilled in the art to attain desirable properties for a specific application and can include, for example, electron-withdrawing groups, electron-donating groups, and steric groups. When a molecule may have two or more substituents, the substituents may be joined together to form a ring such as a fused ring unless otherwise provided. Generally, the above groups and substituents thereof may include those having up to 48 carbon atoms, typically 1 to 36 carbon atoms and usually less than 24 carbon atoms, but greater numbers are possible depending on the particular substituents selected.

Pigment-based ink compositions employing non-self-dispersed pigments that are useful in pigmented printing fluids of the invention may be prepared by any method known in the art of inkjet printing. Useful methods commonly involve two steps: (a) a dispersing or milling step to break up the pigments to desirable particle size, and (b) a dilution step in which the pigment dispersion from step (a) is diluted with the remaining printing fluid components to give a working strength ink. The milling step (a) is carried out using any type of grinding mill such as a media mill, a ball mill, a two-roll mill, a three-roll mill, a bead mill, an air-jet mill, an attritor, or a liquid interaction chamber. In the milling step (a), pigments are optionally suspended in a medium that is typically the same as or similar to the medium used to dilute the pigment dispersion in step (b). Inert milling media are optionally present in the milling step (a) in order to facilitate break up of the pigments to desired particle size. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

A dispersant is present in the milling step (a) in order to facilitate break up of the pigments. For the pigment dispersion obtained in step (a) or the ink composition obtained in step (b), a dispersant is present in order to maintain particle stability and prevent settling. The dispersant for the pigment particles can be a surfactant, such as for example, potassium oleylmethyl taurate (KOMT), sodium dodecyl sulfate or sodium dioctyl sulfosuccinate.

Polymeric dispersants can be used to disperse the pigment particles prior to, or during the milling step. Typically, these polymeric dispersants are copolymers made from hydrophobic and hydrophilic monomers. Examples of polymeric dispersants for pigment particles include random and block copolymers having hydrophilic and hydrophobic portions; see for example, U.S. Pat. Nos. 4,597,794, 5,085,698, 5,519,085, 5,272,201, 5,172,133, and 6,043,297, and PCT Patent Publication Number WO 2004/111140A1; and graft copolymers; see for example, U.S. Pat. Nos. 5,231,131, 6,087,416, 5,719,204, and 5,714,538. Among these polymeric dispersants anionic polymeric dispersants are especially useful.

Polymeric dispersants useful for dispersing the pigment particles employed in the present invention are not limited in the arrangement of the monomers comprising the dispersant. The arrangement of monomers may be totally random, or they may be arranged in blocks such as AB or ABA wherein, A is the hydrophobic monomer and B is the hydrophilic monomer. In addition, the polymer may take the form of a random terpolymer or an ABC tri-block wherein, at least one of the A, B and C blocks is chosen to be the hydrophilic monomer and the remaining blocks are hydrophobic blocks dissimilar from one another.

Polymeric dispersants useful for dispersing the pigment particles can be selected from acrylics and styrene-acrylics. Styrene-acrylic polymeric dispersants especially useful in the present invention are copolymers of styrenic monomers and carboxylate monomers. Examples of such dispersants include copolymers of styrene or alphamethyl styrene and acrylic acid or methacrylic acid (such as the JONCRYL (BASF) or TRUDOT (Mead Westvaco) polymers) or styrene maleic anhydride and styrene maleic anhydride amic acid copolymers (such as SMA-1440, SMA-17352, SMA-1000, SMA-2000 (Sartomer Inc.)).

Acrylic polymeric dispersants useful in the present invention are typically formed from one or more acrylic monomer and one or more ionizable monomer, such as, for example carboxylated or sulfonated monomers. Acrylic polymeric dispersants are typically formed from one or more hydrophobic acrylate monomer including, for example, methylmethacrylate, ethylmethacrylate, butylmethacrylate, hexylmethacryate, octylmethacrylate and decylmethacrylate.

Other especially useful polymeric dispersants are those where the hydrophobic monomer is selected from benzyl methacrylate or acrylate, or from acrylic acid esters containing an aliphatic chain having twelve or more carbons and where the hydrophilic monomer is a carboxylated monomer. Examples of acrylic acid esters having twelve or more carbons include; lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, and decyltetradecyl methacrylate. Preferably the methacrylate or acrylate monomer is stearyl or lauryl methacrylate or acrylate. The hydrophobic portion of the polymer may be prepared from one or more of the hydrophobic monomers. Desirable carboxylated hydrophilic monomers are acrylic acid or methacrylic acid, or combinations thereof.

Typically, the weight average molecular weight of the polymeric dispersant has an upper limit such that it is less than 50,000 Daltons. Desirably the weight average molecular weight of the copolymer is less than 25,000 Daltons; more desirably it is less than 15,000 and most desirably less than 10,000 Daltons. The copolymer dispersants preferably have a weight average molecular weight lower limit of greater than 500 Daltons.

In one exemplary embodiment, the pigment particles are dispersed with a copolymer where the hydrophobic monomer is benzyl methacrylate and is present from 50 weight percent to 80 weight percent relative to the total weight of the polymeric dispersant and the hydrophilic monomer is methacrylic acid.

In a second embodiment, copolymer dispersants are employed which comprise a hydrophobic monomer having a carbon chain length of greater than or equal to 12 carbons present in an amount of at least 10% by weight of the total copolymer, and more desirably greater than 20% by weight, an optional additional hydrophobic monomer comprising an aromatic group and a hydrophilic monomer that is methacrylic acid. For example, the additional aromatic group containing monomer may be benzyl acrylate or benzyl methacrylate. An especially useful additional monomer is benzyl methacrylate.

The total amount of hydrophobic monomers, comprising the monomer having a chain with greater than or equal to 12 carbons and optionally, monomer containing an aromatic group, may be present in the polymer in an amount of 20 to 95% by weight of the total polymer. The hydrophobic aromatic-group containing monomer may be present in an amount from about 0 to 85% by weight of the total polymer, more typically from about 0 to 60%, and desirably from about 0 to 50%. A particularly useful embodiment of a polymeric dispersant for the pigment particles is a terpolymer of benzyl methacrylate, stearyl methacrylate and methacrylic acid. Particularly useful polymeric pigment dispersants are further described in US Patent Publication Numbers 2006/0012654 and 2007/0043144, the disclosures of which are incorporated by reference herein.

Encapsulating type polymeric dispersants and polymeric dispersed pigments thereof can also be used in the invention. Specific examples are described in U.S. Pat. Nos. 6,723,785, 6,852,777, and US Patent Publication Numbers 2004/0132942, 2005/0020731, 2005/0009951, 2005/0075416, 2005/0124726, 2004/0077749, and 2005/0124728. Encapsulating type polymeric dispersants can be especially useful because of their high dispersion stability on keeping and low degree of interaction with ink components. Composite colorant particles having a colorant phase and a polymer phase are also useful in aqueous pigment-based printing fluids of the invention. Composite colorant particles are formed by polymerizing monomers in the presence of pigments; see for example, US Patent Publication Numbers 2003/0199614, 2003/0203988, or 2004/0127639. Microencapsulated-type pigment particles are also useful and consist of pigment particles coated with a resin film; see for example U.S. Pat. No. 6,074,467.

The pigment particles useful in the invention may have any particle size that can be jetted through a printhead. Preferably, the pigment particles have a volume weighted mean particle size of less than about 0.5 micron. The pigment dispersions useful in pigment-based printing fluid compositions employed in the present invention desirably have a median particle diameter of less than 200 nm and more desirably less than 150 nm. In a particularly useful embodiment, 90 percent of the weight of the pigment particles in the distribution have a diameter less than 150 nm and desirably less than 100 nm.

Self-dispersing pigments, i.e., pigments that are dispersible without the use of a separate dispersant or surfactant, useful for the practice of the invention are those that have been subjected to a surface treatment such as oxidation/reduction, acid/base treatment, or functionalization through coupling chemistry. The surface treatment can render the surface of the pigment with anionic, cationic, or non-ionic groups. The preparation and use of covalently functionalized self-dispersed pigments suitable for inkjet printing are reported by Bergemann et al. in U.S. Pat. No. 6,758,891 and U.S. Pat. No. 6,660,075; Belmont in U.S. Pat. No. 5,554,739; Adams and Belmont in U.S. Pat. No. 5,707,432; Johnson and Belmont in U.S. Pat. No. 5,803,959 and U.S. Pat. No. 5,922,118; Johnson et al. in U.S. Pat. No. 5,837,045; Yu et al. in U.S. Pat. No. 6,494,943; in published applications WO 96/18695, WO 96/18696, WO 96/18689, WO 99/51690, WO 00/05313, and WO 01/51566; Osumi et al. in U.S. Pat. No. 6,280,513 and U.S. Pat. No. 6,506,239; Karl et al. in U.S. Pat. No. 6,503,311; Yeh, et al. in U.S. Pat. No. 6,852,156; Ito et al. in U.S. Pat. No. 6,488,753; and Momose et al. in EP 1,479,732. Examples of commercially available self-dispersing type pigments include CAB-O-JET 200, CAB-O-JET-250, CAB-O-JET-260, CAB-O-JET-270, and CAB-O-JET 300 (Cabot Specialty Chemicals, Inc.); BONJET CW-1, CW-2 and CW-3 (Orient Chemical Industries, Ltd.); and AQUA BLACK 162 and 001 (Tokai Carbon, Ltd.).

A wide variety of organic and inorganic pigments, alone or in combination with additional pigments or dyes, can be in the present invention. Pigments that may be used in the invention include those disclosed in, for example, U.S. Pat. Nos. 5,026,427; 5,085,698; 5,141,556; 5,160,370; and 5,169,436. The exact choice of pigments will depend upon the specific application and performance requirements such as color reproduction and image stability. Dispersed pigment particles are typically present at from 1 to 10 wt % in the pigmented inkjet printing fluids of the invention, preferably 1 to 6 wt %. Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black.

Typical examples of organic pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; and C.I. Pigment Brown 1, 5, 22, 23, 25, 38, 41, 42.

Printing fluid compositions of the invention may also preferably comprise a humectant in order to achieve reliable firing at high frequency with low velocity variability. Representative examples of humectants which may be employed in the present invention include: (1) triols, such as; glycerol, 1,2,6-hexanetriol, 2-ethyl-2-hydroxymethyl-propane diol, trimethylolpropane, alkoxlated triols, alkoxylated pentaerythritols, saccharides, and sugar alcohols; and (2) diols, such as ethylene glycol, diethylene glycol, triethylene glycol, propylene glycol, polyalkylene glycols having four or more alkylene oxide groups, 1,3-propane dial, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane dial, 1,2-octane diol, 2,2,4-trimethyl-1,3-pentane diol, 1,8-octane diol; and thioglycol or a mixture thereof. Desirable humectants are polyhydric alcohols having three or more hydroxyl groups. A particularly useful humectant is glycerol.

Typical aqueous-based ink compositions for drop-on-demand thermal printhead systems useful in the invention may contain, e.g., 5-35 weight percent humectant(s), especially from 6-25% humectant, most desirably from about 7-20% humectant. Inks comprising humectants having the aforementioned viscosity and concentration ranges are ideal for maintaining ink viscosities in an acceptable range for high speed firing from a thermal inkjet printhead with low variability in firing velocity. While higher levels may be typically preferred for use in drop-on-demand printers, the total humectant level of printing fluid compositions for CIJ printing is desirably 10% or less by weight, more preferably 8% or less by weight, and most preferably 6% or less by weight. A preferred range of humectant for CIJ printing fluids is from 0.5 to about 8% by weight, more preferably from 0.5 to about 6% by weight. The total humectant level of the ink is the sum of the individual sources of humectant ingredients, which may include humectant added directly during ink formulation, and for example humectant associated with a commercial biocide preparation as a supplemental ingredient, or with a commercial pigment dispersion preparation that may be present to prevent so-called “paint-flakes” of dried pigment cake forming around a bottle cap, as described in US Patent publication no. 2005/0075415 A1 to Harz et al. More desirably, the total humectant level is from about 1% to less than 10%, in order to facilitate drying of the inkjet printing recording material in a high speed printer while simultaneously encouraging higher equilibrium moisture content in dried ink film on hardware for redispersion and clean-up by ink, or by start-up and shut-down fluids, or by a printhead storage fluid.

The printing fluid compositions of the present invention may also include a water miscible co-solvent or penetrant. Representative examples of co-solvents used in the aqueous-based printing fluid compositions include: (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) lower mono- and di-alkyl ethers derived from the polyhydric alcohols; such as ethylene glycol monomethyl ether, ethylene glycol monobutyl ether, ethylene glycol monoethyl ether acetate, diethylene glycol monomethyl ether, and diethylene glycol monobutyl ether acetate; (3) nitrogen-containing compounds, such as urea, 2-pyrrolidinone, N-methyl-2-pyrrolidinone, imidazolidinone, and 1,3-dimethyl-2-imidazolidinone; and (4) sulfur-containing compounds, such as 2,2′-thiodiethanol, dimethyl sulfoxide, and tetramethylene sulfone. Typical aqueous-based printing fluid compositions of the invention may contain 2-15 weight percent co-solvent(s).

The pH of the aqueous printing fluid compositions of the invention may be adjusted by the addition of organic or inorganic acids or bases. Inorganic bases are preferred; however, small amounts of organic bases, such as triethanolamine, may be used to adjust the pH of the printing fluid. Useful printing fluids for drop-on-demand applications may have a preferred pH of from about 4 to 10, depending upon the type of pigment being used. Preferably, the pH of such printing fluid is from 6 to 9, more preferably from 7 to 9. The pH of the inkjet ink composition directed at CIJ is desirably adjusted from about 7 to about 12; more desirably, the pH is about 8 to 10. When the ink composition is used in hardware with nickel or nickel-plated apparatus components, an anticorrosion inhibitor such as the sodium salt of 4- or 5-methyl-1-H-benzotriazole is desirably added and the pH adjusted to be from about 10 to about 11. When the ink composition is used with printheads with components fabricated from silicon that are in contact with the fluid, the ink composition pH is desirably adjusted to be from about 7 to about 9.5; more desirably, the pH ranges from about 7.5 to about 9. In order to reduce the risk of excessively protonating carboxylate anions associated with polymeric dispersants and anionic charge stabilized anti-abrasion polymers that might render the ink composition more susceptible to flocculation, pH levels lower than about 7 are desirably avoided. With hardware components fabricated from silicon in contact with the ink composition, pH levels higher than about 10 can induce significant rates of etch and corrosion that may impair the operation of the device over time. Typical inorganic acids include nitric, hydrochloric, phosphoric, and sulfuric acids. Typical organic acids include methanesulfonic, acetic, formic, and lactic acids. Typical inorganic bases include alkali metal hydroxides and carbonates. Typical organic bases include ammonia, triethanolamine, and tetramethylethlenediamine. Amine bases especially desirable in the application of the invention to CIJ printing include 3-amino-1-propanol, N,N-dimethanolamine, N,N-dimethylethanolamine, N,N-diethylethanolamine, and triethanolamine. The well known Goods buffers can also be employed.

The inks of the invention may contain surfactants added to adjust the static surface tension or dynamic surface tension of the ink to an appropriate level. The surfactants may be anionic, cationic, amphoteric, or nonionic and used at, e.g., levels of 0.01 to 5% of the ink composition. Defoaming agents comprised of phosphate esters, polysiloxanes, or acetylenic diols may further optionally be used with the ink compositions directed at CIJ to reduce foam formation caused by the fluid agitation associated with drop catching and ink recirculation.

The pigment-based printing fluid compositions of the present invention may also contain a water-soluble acrylic polymer comprising carboxylic acid groups. The term “water-soluble” is defined herein as when the polymer is dissolved in water and when the polymer is at least partially neutralized with an inorganic monovalent base the resultant solution is visually clear. Acrylic polymers which may be employed in the present invention are exemplified by those disclosed in U.S. Pat. No. 6,866,379, which is incorporated herein in its entirety by reference. To avoid undesired viscosity increases, however, such water-soluble acrylic polymers are either not employed or employed at concentrations lower than that of the acrylic latex polymers.

The exact choice of ink components will depend upon the specific application and performance requirements of the printhead from which they are to be jetted. Desirable viscosities are no greater than 10 cP, preferably in the range of 1.0 to 4.0 cP, and more preferably 1.0 to 3.0 cP. Printing fluid compositions defined by these desirable embodiments are capable of achieving high firing frequencies with low variability for a large number of firing events.

Surfactants may be added to adjust the surface tension of the printing fluid to an appropriate level. In a particular embodiment, relative dynamic and static surface tensions of various pigment based printing fluids and clear protective printing fluid of an ink set may be controlled as described in US Publication Number 2008/0207805, the disclosure of which is incorporated by reference herein, to control intercolor bleed between the inks. The surfactants may be anionic, cationic, amphoteric, or nonionic and used at levels of 0.01 to 5% of the ink composition. Examples of suitable nonionic surfactants include, linear or secondary alcohol ethoxylates (such as the TERGITOL 15-S and TERGITOL TMN series available from Union Carbide and the BRIJ series from Uniquema), ethoxylated alkyl phenols (such as the TRITON series from Union Carbide), fluoro surfactants (such as the ZONYLS from DuPont; and the FLURADS from 3M), fatty acid ethoxylates, fatty amide ethoxylates, ethoxylated and propoxylated block copolymers (such as the PLURONIC and TETRONIC series from BASF, ethoxylated and propoxylated silicone based surfactants (such as the SILWET series from CK Witco), alkyl polyglycosides (such as the GLUCOPONS from Cognis), and acetylenic polyethylene oxide surfactants (such as the Surfynols from Air Products, Inc.).

Examples of anionic surfactants include carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates, and alkyl naphthalene sulfonates), phosphated (such as phosphated esters of alkyl and aryl alcohols, including the STRODEX series from Dexter Chemical), phosphonated and amine oxide surfactants, and anionic fluorinated surfactants. Examples of amphoteric surfactants include betaines, sultaines, and aminopropionates. Examples of cationic surfactants include quaternary ammonium compounds, cationic amine oxides, ethoxylated fatty amines, and imidazoline surfactants. Additional examples of the above surfactants are described in “McCutcheon's Emulsifiers and Detergents,” 1995, North American Edition.

A biocide (0.01-1.0% by weight) may also be added to prevent unwanted microbial growth which may occur in the printing fluid over time. A preferred biocide for the printing fluids employed in the present invention is PROXEL GXL (Zeneca Colours Co.) at a concentration of 0.05-0.1% by weight or/and KORDEK (Rohm and Haas Co.) at a concentration of 0.05-0.1% by weight (based on 100% active ingredient). Additional additives which may optionally be present in an inkjet printing fluid composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers, and defoamers.

The invention is summarized above. Inkjet printing systems useful in the invention comprise a printer, at least one printing fluid as described above, and an image recording element, typically a sheet (herein also “media”), suitable for receiving printing fluid from an inkjet printer. The method of the invention employs the inkjet printing system of the invention to provide an image on media. Inkjet printing is a non-impact method for producing printed images by the deposition of printing fluid droplets in a pixel-by-pixel manner to an image-recording element in response to digital data signals. There are various methods that may be utilized to control the deposition of printing fluid droplets on the image-recording element to yield the desired printed image, as further discussed above.

The following examples illustrate, but do not limit, the utility of the present invention.

### Example 1

### Synthesis of Acrylic Polymer Latexes AP-1 to AP-6 used in Ink Examples

Acrylic polymers are made by emulsion polymerization using RHODACAL A246L as surfactant and potassium persulfate as initiator. Acrylic polymer dispersions typically range in size from 30 to 150 nm, and weight average molecular weights of approx 10,000 to 1,000,000.

Acrylic polymer AP-1: a copolymer of Ethylmethacrylate and methacrylic acid (95/5 weight ratio) having an acid number of about 33. Polymer is neutralized with potassium hydroxide. Degree of neutralization is 25%.

Acrylic polymer AP-2: a copolymer of Ethylmethacrylate and methacrylic acid (90/10 weight ratio) having an acid number of about 66. Polymer is neutralized with potassium hydroxide. Degree of neutralization is 25%.

Acrylic polymer AP-3: a copolymer of n-butylmethacylate and methacrylic acid (90/10 weight ratio) having an acid number of about 66. Polymer is neutralized with potassium hydroxide. Degree of neutralization is 25%.

Acrylic polymer AP-4: a copolymer of Ethylmethacrylate, methacrylic acid, Methoxy polyethylene glycol methacrylate, and Tetramethylene diacrylate (75/10/5/10 weight ratio) having an acid number of about 67. Polymer is neutralized with potassium hydroxide. Degree of neutralization is 25%.

Acrylic polymer AP-5: a copolymer of Ethylmethacrylate, methacrylic acid, and Methoxy polyethylene glycol methacrylate (90/5/5 weight ratio) having an acid number of about 33. Polymer is neutralized with potassium hydroxide. Degree of neutralization is 100%.

Acrylic polymer AP-6: a copolymer of Ethylmethacrylate, Potassium 3-sulfopropyl methacrylate, and Methoxy polyethylene glycol methacrylate (90/5/5 weight ratio).

### Example 2

### Synthesis of Acrylic Solution Polymers AP-7 to AP9 used in Ink Examples

Acrylic solution polymers are made by solution polymerization in 1-methoxy-2-propanol using a vazo initiator and Dodecanethiol as chain transfer agent. Resulting weight average molecular weights are approx 5,000 to 20,000.

Acrylic polymer AP-7: a copolymer of Benzylmethacrylate and methacrylic acid having an acid number of about 205. Polymer is neutralized with potassium hydroxide. Degree of neutralization is 90%.

Acrylic polymer AP-8: a copolymer of Benzylmethacrylate and Methacrylic acid having an acid number of about 69. Polymer is neutralized with potassium hydroxide. Degree of neutralization is 90%.

Acrylic polymer AP-9: a copolymer of Benzylmethacrylate and methacrylic acid having an acid number of about 155. Polymer is neutralized with potassium hydroxide. Degree of neutralization is 90%.

### Example 3

### Synthesis of the Polyurethanes PU-1 through PU-11

Polymerizations are carried out in either tetrahydrofuran (THF) or ethyl acetate (EA) using isophorone diisocynate, 2,2-bis(hydroxymethyl)proprionic acid, and polyol. The resulting polymer is neutralized with KOH and diluted with water. The organic solvent is removed by vacuum distillation. Resulting polyurethane dispersions typically have a size range from 10 to 40 nm, and weight average molecular weights of approx 6,000 to 50,000.

PU-1: Acid number 76 polyurethane made with isophorone diisocyanate, 2,2-bis(hydroxymethyl)proprionic acid, 2000 Mw polycarbonate polyol in tetrahydrofuran. 90% of acid groups neutralized with potassium hydroxide.

PU-2: Acid number 76 polyurethane made with isophorone diisocyanate, 2,2-bis(hydroxymethyl)proprionic acid, 2000 Mw polycarbonate polyol in ethyl acetate. 90% of acid groups neutralized with potassium hydroxide.

PU-3: Acid number 35 polyurethane made with isophorone diisocyanate, 2,2-bis(hydroxymethyl)proprionic acid, 2000 Mw polycarbonate polyol in tetrahydrofuran. 90% of acid groups neutralized with potassium hydroxide.

PU-4: Acid number 105 polyurethane made with isophorone diisocyanate, 2,2-bis(hydroxymethyl)proprionic acid, 2000 Mw polycarbonate polyol in tetrahydrofuran. 90% of acid groups neutralized with potassium hydroxide.

PU-5: Acid number 105 polyurethane made with isophorone diisocyanate, 2,2-bis(hydroxymethyl)proprionic acid, 2000 Mw polycarbonate polyol in ethyl acetate. 90% of acid groups neutralized with potassium hydroxide.

PU-6: Acid number 44 polyurethane made with isophorone diisocyanate, 2,2-bis(hydroxymethyl)proprionic acid, 2000 Mw Terathane polyol in tetrahydrofuran. 100% of acid groups neutralized with potassium hydroxide.

PU-7: An acid number 65 polyurethane made with isophorone diisocyanate, 2,2-bis(hydroxymethyl)proprionic acid, 1,4 butandiol, 2000 Mw Terathane polyol in tetrahydrofuran. 100% of acid groups neutralized with potassium hydroxide.

PU-8: An acid number 80 polyurethane made with isophorone diisocyanate, 2,2-bis(hydroxymethyl)proprionic acid, 1,4 butandiol, 2000 Mw Terathane polyol in tetrahydrofuran. 100% of acid groups neutralized with potassium hydroxide.

PU-9: An acid number 90 polyurethane made with isophorone diisocyanate, 2,2-bis(hydroxymethyl)proprionic acid, 1,4 butandiol, 2000 Mw Terathane polyol in tetrahydrofuran. 100% of acid groups neutralized with potassium hydroxide.

PU-10: Acid number 157 polyurethane made with isophorone diisocyanate and 2,2-bis(hydroxymethyl)proprionic acid, 100% of acid groups neutralized with potassium hydroxide.

PU-11: Acid number 145 polyurethane made with isophorone diisocyanate, 2,2-bis(hydroxymethyl)proprionic acid, 2000 Mw polycarbonate polyol in tetrahydrofuran. 100% of acid groups neutralized with potassium hydroxide.

### Example 4

### Preparation of Polymeric Dispersant P-1

A 5-liter, three-necked round bottom flask equipped with a mechanical stirrer, a reflux condenser, and a gas inlet is charged with 225 g of 1-methoxy-2-propanol and sparged with nitrogen. Akzo-Nobel Chemicals, Inc., initiator PERKADOX AMBN-GR (1.9 g) is added with stirring. A reactant reservoir is charged with 225 g of 1-methoxy-2-propanol, 23.4 g of 1-dodecanethiol, 203.5 g of benzyl methacrylate, 165.0 g of stearyl methacrylate, and 181.5 g of methacrylic acid, and the solution is degassed by nitrogen sparging. AMBN-GR (7.7 g) is added and mixed in. The reactor temperature is raised to 77° C. and the reactants are pumped from the reservoir at about 2.3 mL/min over a 360-min period. The reaction mixture is stirred for at least 12 h at about 77° C. The polymer is neutralized to completion with dimethylaminoethanol and stirred for 45 min. The reaction mixture is diluted with 2,580 g of water and filtered through a Pall Corp. ULTIPLEAT polypropylene cartridge filter. The final polymer solution has a concentration of ca. 20 wt. % solids and its pH is 8.6. The weight average molecular weight is 9,070 Daltons.

### Preparation of Pigment Black NIPEX 180 Dispersion PB-1

To a 2.5-gallon, 9-inch diameter and 12-inch deep, double-walled stainless steel mixing vessel containing four baffles is added water (1,273 g) and a solution of the Polymeric Dispersant P-1 (727 g of a 20.6 wt % solution). A nominal 4-inch, ring-style disperser impeller (Hockmeyer Equipment Corp. D-Blade) driven by a Charles Ross & Son Co. Model HSM-100LH-2 High Shear Mixer is centered 2 inches above the bottom of the mixing vessel, and stirring is initiated. Degussa GmbH. NIPEX 180 IQ carbon black pigment (500 g) is slowly integrated into the fluid. Milling media comprising beads of polystyrene resin (copolymer of styrene and divinylbenzene/ethylvinylbenzene mixture) with an average particle diameter of 50 micrometers (3,000 g) is added slowly while increasing impeller speed. The mixture is milled with an impeller blade tip speed of ca. 19 msec for about 20 h at an internal temperature of 25-35° C. Samples are periodically removed, diluted and filtered for particle size determination by a Microtrac, Inc., NANOTRAC 150 dynamic light scattering analyzer. When milling is complete, the dispersion/media milling mixture is further diluted with a solution of water (2,475 g) and Rohm and Haas Co. KORDEK MLX preservative (25 g) to a final pigment concentration of about 10% and theoretical dispersion batch size of 5000 g. The impeller is removed from the dispersion/media milling mixture, and a vacuum separator filter probe is immersed. The filter probe comprised a 0.25-inch ID TYGON plastic tubing connected to a sealed 2-inch length of 1.25-inch OD tubular, 38-micrometer screen (Johnson Screens, Inc.). A peristaltic pump is used to separate the dispersion from the milling media and it is subsequently filtered through a 0.3-micrometer removal efficiency Pall Corp. PROFILE II depth filter. Roughly 4 kg of dispersion is recovered, approximately 80% yield. The volume-weighted 50^{th} percentile particle size distribution diameter is about 62 nm, and the 95^{th} percentile particle size distribution diameter is about 110 nm.

### Typical Ink Preparation

A pigment black NIPEX 180 pigment based inkjet ink formulation INK-4 containing acrylic latex AP-2 and polyurethanePU-1 was prepared as follows.

Into a 250 ml polyethylene bottle with magnetic stirring the following were added in the order listed: 55.05 g of distilled water, 9.00 g glycerol, 0.20 g of a 50 wt % solution of corrosion inhibitor COBRATEC TT-50S, 0.20 g of a 17 wt % solution of biocide PROXEL GXL, 0.12 g of the nonionic surfactant SURFYNOL 440, 92.63 g of a 21.6 wt % solution of acrylic latex AP-2, 8.13 g of a 24.6 wt % solution of Polyurethane PU-1, 86.54 g of a black pigment dispersion PB-1 containing 10.4 wt % NIPEX 180, and 0.16 g of a 20 wt % solution of defoamer SURFYNOL DF-110L. The resulting 200 mls of ink was stirred for 1 hour and filtered through a 1.0 um GF prefilter and a 1.2 um VERSAPOR filter.

Inks INK-1 through INK-20 were similarly prepared, with acrylic polymers and polyurethanes as indicated in Table 1 below.

### Example 5

### Evaluation of Ink Performance

Ink viscosity was measured using Paar Physica AMVn Rolling Ball Viscometer at 25° C. The result is shown in Table 1.

Optical printing density (OD) was evaluated using the drawdown method. About 8.18 mL/m2 of inks were applied to a paper surface using #3 wire rod. The ink on the paper substrate was air dried. The optical density was measured using Greytag Macbeth SPECTROSCAN. The results of the measurement are shown in Table 1.

Recirculation stability was evaluated by running 125 mls of each ink through a system capable of in-line monitoring of the destabilization of the ink. This system comprised a small reservoir to contain the ink sample, a gear pump, and a filter holder, all connected in a recirculation loop. Reservoir volume was 125 mls. The gear pump used was a MICROPUMP Model 180. The filter used was a 3.0 um VERSAPOR disk filter. The recirculation flow rate was 1 L/minute with a pressure approximately 20 psi at the start. To simulate continuous printing process, it is desirable to have ink keep recirculating through the gear pump with minimal change in the recirculation pressure. The measured pressure change after 2 hours is shown in Table 1.

¹H NMR was used to estimate the amount of free solution polymer that exists in the aqueous dispersions of these acrylic polymers. “Free solution polymer” is defined as that portion which is visible in the NMR spectrum of the aqueous dispersion. An external reference (TSP, integral≡0) is used to compare the polymer signal in two solvents: aqueous and a good solvent. Samples were prepared by adding 50 μL of aqueous polymer dispersion to 1 mL of each solvent, D₂O and CD₂Cl₂:CD₃OD (1:1). It is assumed that the polymer is fully dissolved in CD₂Cl₂:CD₃OD (1:1). % solution polymer estimates are shown in Table 1.

TABLE 1

| | | | | | | Pressure | | | |
|---|---|---|---|---|---|---|---|---|---|
| | | | | acid | wt % | change | | | Acrylic % |
| Ink | | wt % | Poly- | # of | poly- | in 2 hrs | Visc. | | solution |
| sample | acrylic | acrylic | urethane | PU | urethane | (psi) | (mPa · s) | OD | polymer |
| INK-1 | AP-1 | 10.00 | none | NA | 0.00 | ** | 2 | 1.3 | 1.3 |
| INK-2 | AP-1 | 10.00 | PU-1 | 76 | 1.00 | 0.80 | 2.10 | 1.26 | 1.3 |
| INK-3 | AP-2 | 10.00 | none | NA | 0.00 | 2.40 | 2.20 | 1.27 | 4.3 |
| INK-4 | AP-2 | 10.00 | PU-1 | 76 | 1.00 | 0.90 | 2.30 | 1.21 | 4.3 |
| INK-5 | AP-3 | 10.00 | none | NA | 0.00 | *** | 2.00 | 1.26 | 1.3 |
| INK-6 | AP-3 | 10.00 | PU-1 | 76 | 1.00 | ** | 2.10 | 1.22 | 1.3 |
| INK-7 | AP-4 | 10.00 | none | NA | 0.00 | 2.80 | 2.83 | 1.26 | |
| INK-8 | AP-4 | 10.00 | PU-1 | 76 | 1.00 | 0.90 | 2.50 | 1.26 | |
| INK-9 | AP-5 | 10.00 | none | NA | 0.00 | ** | 3.61 | 1.27 | 5.9 |
| INK-10 | AP-5 | 10.00 | PU-1 | 76 | 1.00 | 12.70 | 3.85 | 1.29 | 5.9 |
| INK-11 | AP-6 | 10.00 | none | NA | 0.00 | 5.00 | 2.87 | 1.27 | |
| INK-12 | AP-6 | 10.00 | PU-1 | 76 | 1.00 | 1.20 | 2.97 | 1.32 | |
| INK-13 | AP-8 | 10.00 | none | NA | 0.00 | ** | 3.10 | 1.21 | 21.0 |
| INK-14 | AP-8 | 10.00 | PU-1 | 76 | 1.00 | 37.60 | 3.40 | 1.22 | 21.0 |
| INK-15 | AP-7 | 10.00 | none | NA | 0.00 | 1.40 | 4.00 | 1.00 | 94.0 |
| INK-16 | AP-7 | 10.00 | PU-1 | 76 | 1.00 | 1.00 | 4.60 | 0.96 | 94.0 |
| INK-17 | AP-9 | 10.00 | none | NA | 0.00 | 1.30 | 2.90 | 1.20 | 93.0 |
| INK-18 | AP-9 | 10.00 | PU-1 | 76 | 1.00 | 1.00 | 3.20 | 1.20 | 93.0 |
| INK-19 | none | 0.00 | none | NA | 0.00 | 0.00 | 1.40 | 0.86 | NA |
| INK-20 | none | 0.00 | PU-1 | 76 | 1.00 | 0.00 | 1.45 | 0.87 | NA |

** Plugged filter (pressure exceeded 60 psi) in 1-2 hrs
*** Plugged filter (pressure exceeded 60 psi) in less than 30 minutes

Inks INK-1 to INK-12 containing acrylic latex had low ink viscosity (less than 4 mPa·s) and the printed papers showed high optical density (greater than 1.2). Inks INK-2, INK-4, INK-6, INK-8, INK-10 and INK-12, which further included aqueous polyurethane dispersions in accordance to the present invention demonstrated significant improvement in pressure change compared to corresponding inks INK-1, INK-3, INK-5, INK-7, INK-9 and INK-11 without polyurethane dispersions. Comparative ink INK-13 through INK-18, containing acrylic solution polymers typically resulted in higher viscosities, lower optical densities, or a smaller difference in pressure change due to inclusion of a polyurethane dispersion in comparison to the inks containing the acrylic latex polymers. The invention thus provides the combined advantages of increased optical density, lower viscosity, and significantly improved recirculation stability.

### Example 6

### Evaluation of Acid Number of Polyurethane

Inks INK-21 through INK-34 were prepared similarly as inks INK-1 through INK-20, but with acrylic latex polymer AP-1 and polyurethanes PU-1 through PU-11 as indicated in Table 2. Recirculation stability was evaluated as in Example 5, and the measured pressure change after 2 hours is shown in Table 2.

TABLE 2

| | acryl- | wt % | Polyurethane | acid | | Pressure |
|---|---|---|---|---|---|---|
| Ink | ic | acrylic | (preparation | # of | wt % | change |
| Sample | latex | latex | solvent) | PU | polyurethane | in 2 hrs |
| INK-21 | AP-1 | 10.00 | none | NA | 0.00 | ** |
| INK-22 | AP-1 | 10.00 | PU-1 (THF) | 76 | 1.00 | 0.80 |
| INK-23 | AP-1 | 10.00 | PU-2 (EA) | 76 | 1.00 | 1.14 |
| INK-24 | AP-1 | 10.00 | PU-3 (THF) | 35 | 1.00 | 8.95 |
| INK-25 | AP-1 | 10.00 | PU-5 (EA) | 105 | 1.00 | 18.44 |
| INK-26 | AP-1 | 10.00 | PU-4 (THF) | 105 | 1.00 | 3.68 |
| INK-27 | AP-1 | 10.00 | PU-1 (THF) | 76 | 0.50 | 2.10 |
| INK-28 | AP-1 | 10.00 | PU-1 (THF) | 76 | 2.00 | 0.00 |
| INK-29 | AP-1 | 10.00 | PU-6 (THF) | 44 | 1.00 | 6.10 |
| INK-30 | AP-1 | 10.00 | PU-7 (THF) | 65 | 1.00 | 2.80 |
| INK-31 | AP-1 | 10.00 | PU-8 (THF) | 80 | 1.00 | 3.00 |
| INK-32 | AP-1 | 10.00 | PU-9 (THF) | 90 | 1.00 | 3.20 |
| INK-33 | AP-1 | 10.00 | PU-10 (THF) | 157 | 1.00 | 6.90 |
| INK-34 | AP-1 | 10.00 | PU-11 (THF) | 145 | 1.00 | 4.60 |

** Plugged filter (pressure exceeded 60 psi) in 1-2 hrs

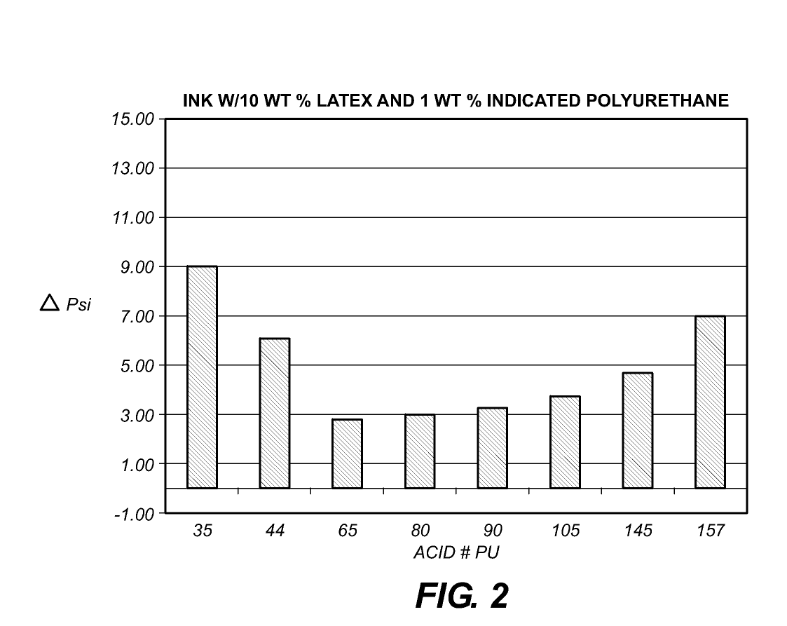

Comparisons of inks INK-22, INK-24, and INK-26 through INK-34 containing polyurethanes prepared in the same manner (each containing a polyurethane prepared in tetrahydrofuran) demonstrates that polyurethanes having an acid number of between 50 and 150, preferably from 60 to 100 and more preferably from 60 to 90, provide improved recirculation stability compared to use of polyurethanes having lower and higher acid numbers. These results are also illustrated in FIG. 2. Comparison of inks INK-23 and INK-25 (each containing a polyurethane prepared in ethyl acetate) similarly demonstrate improved recirculation stability relative to INK-21 containing no polyurethane, and further improved performance for INK-23 including a polyurethane having a preferred acid number of from 60 to 100.

1. An inkjet printing fluid comprising water, colorant, acrylic latex polymer, and a water dispersible polyurethane additive having an acid number greater than 50.

2. The inkjet printing fluid of claim 1, wherein the water dispersible polyurethane additive is of the general formula of 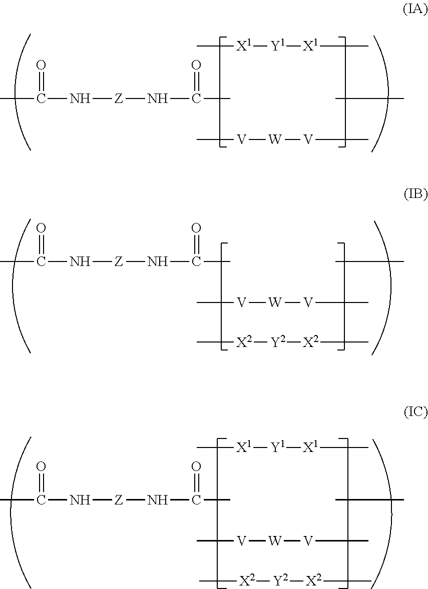
wherein Z is the central portion of a monomer unit that is the polymerization product of a diisocyanate; X¹—Y¹—X¹ represents one or more soft segments wherein Y¹ represents the central portion of a unit that is the polymerization product of a diamine or diol prepolymer having a molecular weight of greater than 300 Daltons; W is the central portion of one or more units containing an acid group; X²—Y²—X² represents one or more hard segments wherein Y² represents the central portion of a unit that is the polymerization product of a C₂-C₈ diol or diamine having a molecular weight of less than or equal to 300 Daltons; and X¹, V and X² can be the same or different and are an —O— or —N— atom.

3. The inkjet printing fluid of claim 2, wherein the polyurethane additive has a weight average molecular weight of at least 6,000 Daltons and a sufficient number of acid groups to provide an acid number between 50 and 150.

4. The inkjet printing fluid of claim 1, wherein the colorant comprises dispersed pigment particles.

5. The inkjet printing fluid of claim 4, wherein the pigment particles are dispersed with a polymeric dispersant, are dispersed with a surfactant, or are self dispersed without the need for a separate dispersant.

6. The inkjet printing fluid of claim 4, wherein the pigment particles are present in the printing fluid at a weight concentration of from 1 to 10%, the acrylic latex polymer is present at a weight concentration of from 2 to 20%, and the polyurethane additive is present at a weight concentration of from 0.5 to 5%.

7. The inkjet printing fluid of claim 6, wherein the weight concentration of the acrylic latex polymer is greater than the weight concentration of the pigment, and the weight concentration of the pigment is greater than the weight concentration of the polyurethane additive.

8. The inkjet printing fluid of claim 4, wherein the pigment particles are present in the printing fluid at a weight concentration of from 1 to 10 wt %.

9. The inkjet printing fluid of claim 4, wherein the weight concentration of the acrylic latex polymer is greater than the weight concentration of the pigment, and the weight concentration of the pigment is greater than the weight concentration of the polyurethane additive.

10. The inkjet printing fluid of claim 4, wherein the printing fluid further comprises at most 10 wt % of humectants.

11. The inkjet printing fluid of claim 1, wherein the acrylic latex polymer is present at a weight concentration of from 1 to 20%.

12. The inkjet printing fluid of claim 1, wherein the polyurethane additive is present at a weight concentration of from 0.5 to 2%.

13. The inkjet printing fluid of claim 1, wherein the printing fluid further comprises at most 10 wt % of humectants.

14. The inkjet printing fluid of claim 1, wherein the polyurethane additive has an acid number between 50 and 150.

15. The inkjet printing fluid of claim 1, wherein the polyurethane additive has an acid number of from 60 to 100.

16. The inkjet printing fluid of claim 1, wherein the polyurethane additive has an acid number of from 60 to 90.

17. The inkjet printing fluid of claim 1, wherein the acrylic latex polymer is present in the printing fluid as dispersed particles with less than 20 wt % of the acrylic latex polymer as free solution polymer.

18. The inkjet printing fluid of claim 1, wherein the acrylic latex polymer is present in the printing fluid as dispersed particles with less than 10 wt % of the acrylic latex polymer as free solution polymer.

19. The inkjet printing fluid of claim 1, wherein the acrylic latex polymer is present in the printing fluid as dispersed particles with less than 4 wt % of the acrylic latex polymer as free solution polymer.

20. The inkjet printing fluid of claim 1, wherein the acrylic latex polymer comprises from 0.5 wt % to 15 wt %, based on the total monomers used to form the latex polymer, of acid monomers.
